(19) United States
(12) Patent Application Publication
(10) Pub. No.: US 2004/0030618 A1
(43) Pub. Date: Feb. 12, 2004

(54) Computer-implemented method and system of payment of indirect materials

(76) Inventor: Edward G. Rosenquist, Plymouth, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 10/464,263

(22) Filed: Jun. 18, 2003

Related U.S. Application Data
(60) Provisional application No. 60/390,010, filed on Jun. 19, 2002.

(51) Int. Cl. G06F 17/60

(52) U.S. Cl. 705/28

(57) ABSTRACT

A program for controlling a computer of a server for determining timing of payment of inventory items is disclosed. The program can include instructions for receiving a plurality of payment on use (POU) and payment on receipt (POR) inventory item descriptions, supplied by an at least one supplier, receiving a POR purchase order receipt for at least one POR inventory item upon receipt of the at least one POR inventory item, receiving a POU purchase order receipt for at least one POU inventory items upon use of the at least one POU inventory item, transmitting a payment message with respect to the at least one used POU or POR inventory item based on the POU or POR purchase order receipt, respectively, and automatically converting at least one POR or POU inventory item into at least one POU or POR inventory item, respectively.

### CROSS-REFERENCE TO RELATED APPLICATION

This application claims the benefit of U.S. Provisional application Serial No. 60/390,010, filed Jun. 19, 2002, and entitled “Method And System Of Payment On Use For Indirect Materials.”

### BACKGROUND OF THE INVENTION

1. Field of the Invention

One of the aspects of the present invention relates generally to a method and system of payment on use and, more specifically, a method and system of payment on use for indirect materials in a distributed enterprise.

2. Background Art

A distributed enterprise refers to an organization having multiple operations spread across multiple geographic regions, including continents and the entire world. Distributed enterprises commonly have plants spread across multiple geographic regions. Distributed enterprises often do not want to take ownership of indirect materials upon physical receipt for tax and payment reasons. Instead, the enterprise takes ownership upon usage of the goods during the manufacturing or maintenance process. After official notification of usage in the manufacturing or maintenance process, the distributed enterprise pays the supplier. During the period of time between physical receipt and usage, the payment on use items (POU) are commonly tracked.

Payment on use presents a unique challenge to conventional electronic procurement management software. Most procurement systems are tailored to effectively meet the needs of smaller to mid-sized businesses that do not incorporate payment on use. These conventional systems lack functionality to effectively support certain business needs of distributed enterprises that utilize payment on use.

Traditionally, electronic data interchange (EDI) and virtual private network (VPN) technologies have enable businesses and their suppliers to exchange invoices, purchase orders, and other documents to conduct their day-to-day business online. Typically, these systems were proprietary in nature, required a dedicated technical infrastructure, and required a costly subscription or pay-per-use access arrangement.

The advent of the Internet has revolutionized electronic procurement systems by increasing the speed and decreasing the cost associated with the first-generation systems. Without such access barriers, buyers are presented with a broader horizon of potential suppliers. Today, a buyer organization can access the Internet to obtain pricing information, product and service information, submit a purchase request, route the request for approval, view the fulfillment status of the request, receive a receipt and delivery notification, and transmit payment.

According to one IDC survey conducted in September 2000, the amount of savings generated with the use of an Internet-enabled procurement system will, on average, range from 5.0% to 8.5% of a company's purchasing budget. Depending on the size of the company, this savings can translate to over a billion dollars annually.

Today, distributed enterprises, such as General Electric and Compaq Computer, have integrated electronic procurement systems to streamline the online sourcing and purchasing of direct and indirect materials. For example, Compaq Computer employees can use their Web browser to view an online supplier catalog of over 37,000 items, and easily purchase the resources necessary to satisfy their day-to-day needs. Companies such as Compaq can expand this functionality to increase the variety of resources available, rationalize its supply base, and consolidate its supply chain in an effort to leverage purchase volumes into fewer suppliers and improve its relationship with a preferred supply base.

One electronic procurement application is Oracle Procurement. A more detailed description of the Oracle Procurement application can be found at www.oracle.com. In standard Oracle functionality, a distributed enterprise takes ownership of materials at receipt. Receivers perform a purchase order receipt for goods sent from suppliers, and the inventory is accounted for as an asset immediately upon receipt.

A payment is generated by Evaluated Receipt Settlement (ERS). Because the ERS payment is generated as a direct result of the physical receipt, the material is treated as payment on receipt (POR), instead of payment on use.

Other developers of procurement solutions include Ariba (www.ariba.com), i2 (www.i2.com), CommerceOne (www.commerceone.com), SAP (www.sap.com) and PeopleSoft (www.peoplesoft.com).

Issued U.S. patents relating to electronic procurement applications and systems include U.S. Pat. No. 5,970,475 to Barnes et al. and U.S. Pat. No. 6,363,365 to Kou. Published U.S. patent applications relating to electronic procurement applications and systems include U.S. Patent Application No. 2001/0042050 to Fletcher et al. Additional information relating to electronic procurement systems includes Albert Pang's IDC White Paper eProcurement Ensures Visionary Companies a Place in the New Economy, July 2001.

Although today's procurement systems may be comprehensive and beneficial, the systems suffer from certain disadvantages relating to payment on use. For example, under current systems distributed enterprises must use payment on receipt, which does not fit their business model.

There is a need to provide a method and system of payment on use for indirect materials. Additionally, a method and system is needed to track payment on use items.

### SUMMARY OF THE PRESENT INVENTION

According to a first embodiment of the present invention, a program for controlling a computer of a server for determining timing of payment of inventory items is disclosed. The program can include instructions for receiving a plurality of payment on use (POU) and payment on receipt (POR) inventory item descriptions for a plurality of POU and POR inventory items, respectively, supplied by an at least one supplier, instructions for receiving a POR purchase order receipt for at least one POR inventory item upon receipt of the at least one POR inventory item, instructions for receiving a POU purchase order receipt for at least one POU inventory items upon use of the at least one POU inventory item, instructions for transmitting a payment message with respect to the at least one used POU or POR inventory item based on the POU or POR purchase order receipt, respectively, and instructions for automatically converting at least one POR or POU inventory item into at least one POU or POR inventory item, respectively.

The plurality of POU and POR inventory items can be maintained in an inventory crib of an at least one plant. The at least one supplier can be assigned to an at least one supplier organization. The at least one plant can be assigned to an at least one plant organization.

In certain embodiments, the program can further include instructions for causing maintenance of a dock receipt and an on-hand balance for each POU inventory item. The program can further include instructions for scheduling the plurality of POU inventory items for a cycle count based on a cycle count guideline. The program can further include instructions for determining a cycle count discrepancy based on the cycle count. The program can further include instructions for determining a schedule for a physical count of the plurality of POU inventory items. The program can further include instructions for determining a physical cycle count discrepancy based on the physical count. The program can also further include instructions for maintaining an inventory item record for the plurality of POU inventory items. The program can further include instructions for assigning a stock locator to each of the plurality of POU inventory items to the at least one purchaser. The program can further include instructions for assigning a stock locator to each of the plurality of POU inventory items to the at least one supplier.

According to a second embodiment of the present invention, a computer-implemented method for determining timing of payment of inventory items is disclosed. The method includes receiving a plurality of payment on use (POU) inventory item descriptions for a plurality of POU inventory items supplied by an at least one supplier, causing requisition of at least one used POU inventory item maintained in the inventory crib by creating a purchase order receipt, receiving the purchase order receipt for at least one POU inventory items upon use of the at least one POU inventory item, and transmitting a payment request with respect to the at least one used POU inventory item based on the purchase order receipt.

The plurality of POU inventory items can be maintained in an inventory crib of an at least one plant. The at least one supplier can be assigned to an at least one supplier organization. The at least one plant can be assigned to an at least one plant organization.

In certain embodiments, the method can further include converting an at least one POU inventory item into an at least one POR inventory item. The method can also include maintaining a dock receipt and an on-hand balance for each POU inventory item. In certain situations, the causing requisition step occurs prior to the causing payment step. Moreover, the method can further include receiving the plurality of POU inventory items at an at least one receiving dock. The method can further include scheduling the plurality of POU inventory items for a cycle count based on a cycle count guideline.

In certain embodiments, the method can include comprising determining a cycle count discrepancy based on the cycle count. The method can further include determining a schedule for a physical count of the plurality of POU inventory items. Additionally, the method can further include calculating a physical cycle count discrepancy based on the physical count. The method can further include maintaining an inventory item record for the plurality of POU inventory items. Another step that the method can further include is assigning a stock locator to each of the plurality of POU inventory items to the at least one purchaser. The method can also further include assigning a stock locator to each of the plurality of POU inventory items to the at least one supplier. The method can further include storing and maintaining pay on receipt (POR) inventory items in the inventory crib.

In other embodiments, the method can further include cycle counting the plurality of POU inventory items and the plurality of POR inventory items. The method can further include window requisitioning the plurality of POU inventory items and the plurality of POR inventory items. The method can further include credit requisitioning the plurality of POU inventory items and the plurality of POR inventory items. The method can further include receiving the plurality of POR inventory items at the at least one receiving dock. The method can further include maintaining a plurality of blanket purchase orders for at least one POU inventory item and the maintaining step can be at least partially executed by the at least one supplier. The method can further include aiding in the display of a POU status for at least one POU inventory item. The POU status can be selected from the group consisting of a requisitions, purchase orders, receipts, and balances. The method can further include displaying the POU status on a stock summary user interface. The method can further include shop floor requisitioning the plurality of POU inventory items and the plurality of POR inventory items.

According to a third embodiment of the present invention, a computer-implemented system for determining timing of payment of inventory items is disclosed. The system can include an at least one server computer for serving at least one client computer. The at least one server computer can be configured to: receive a plurality of inventory item descriptions for a plurality of POU inventory items, cause requisition of an at least one used POU inventory item maintained in the inventory crib by creating a purchase order receipt, receive the purchase order receipt for at least one POU inventory items upon use of the at least one POU inventory item, and transmit a payment message with respect to the at least one used POU inventory item based on the purchase order receipt. The plurality of POU inventory items can be maintained in an inventory crib of an at least one plant. The at least one supplier can be assigned to an at least one supplier organization. The at least one plant can be assigned to an at least one plant organization.

In certain embodiments, the server computer can include an at least one supplier database and the at least one server computer can be further configured to maintain a dock receipt and an on-hand balance for each POU inventory item in the at least one supplier database.

According to a fourth embodiment of the present invention, a computer-implemented system for determining timing of payment of inventory items. The system can include at least one client computer for communicating with at least one server computer. The at least one client computer can be configured to: transmit an inventory item description for a plurality of payment on use (POU) inventory items, cause requisition of an at least one used POU inventory item maintained in the inventory crib by creating a purchase order receipt, transmit the purchase order receipt for at least one POU inventory items upon use of the at least one POU inventory item, and cause payment of the at least one used POU inventory item based on the purchase order receipt. The plurality of POU inventory items can be maintained in an inventory crib of an at least one plant. The at least one supplier can be assigned to an at least one supplier organization. The at least one plant can be assigned to an at least one plant organization.

According to a fifth embodiment of the present invention, a computer-readable product for determining timing of payment of inventory items is disclosed. The product is produced by a computer-implemented process. The process can include receiving a plurality of payment on use (POU) inventory item descriptions for a plurality of POU inventory items supplied by an at least one supplier, receiving a purchase order receipt for at least one POU inventory items upon use of the at least one POU inventory item, and storing the plurality of POU inventory item descriptions and the purchase order receipt in a computer-readable product for use in payment of POU inventory items upon use. The plurality of POU inventory items can be physically stored and maintained in an inventory crib of an at least one plant. The at least one supplier can be assigned to an at least one supplier organization. The at least one plant being assigned to an at least one plant organization.

The above embodiments and other embodiments, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may be best understood with reference to the following description, taken in connection with the accompanying drawings:

FIG. 1 depicts a schematic diagram illustrating a system embodiment for implementing certain embodiments of the present invention;

FIG. 2 is a block flow diagram illustrating an overview of a pay on use inventory strategy with respect to a plant inventory organization;

FIG. 3 is a block flow diagram illustrating an overview of a pay on use inventory strategy with respect to a supplier inventory organization;

FIG. 4 is a block flow diagram illustrating an overview of a pay on use inventory strategy with respect to a plant sub-inventory within a plant inventory organization;

FIG. 5 is a block flow diagram illustrating an overview of a pay on use inventory strategy with respect to a plant operating unit;

FIG. 6 is a block flow diagram illustrating an overview of a pay on use inventory strategy with respect to a supplier operating unit; and

FIG. 7 depicts a workflow tracking form that can be implemented within oracle procurement in accordance with an embodiment of the present invention.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art to variously employ the present invention.

### Pay On Use Overview

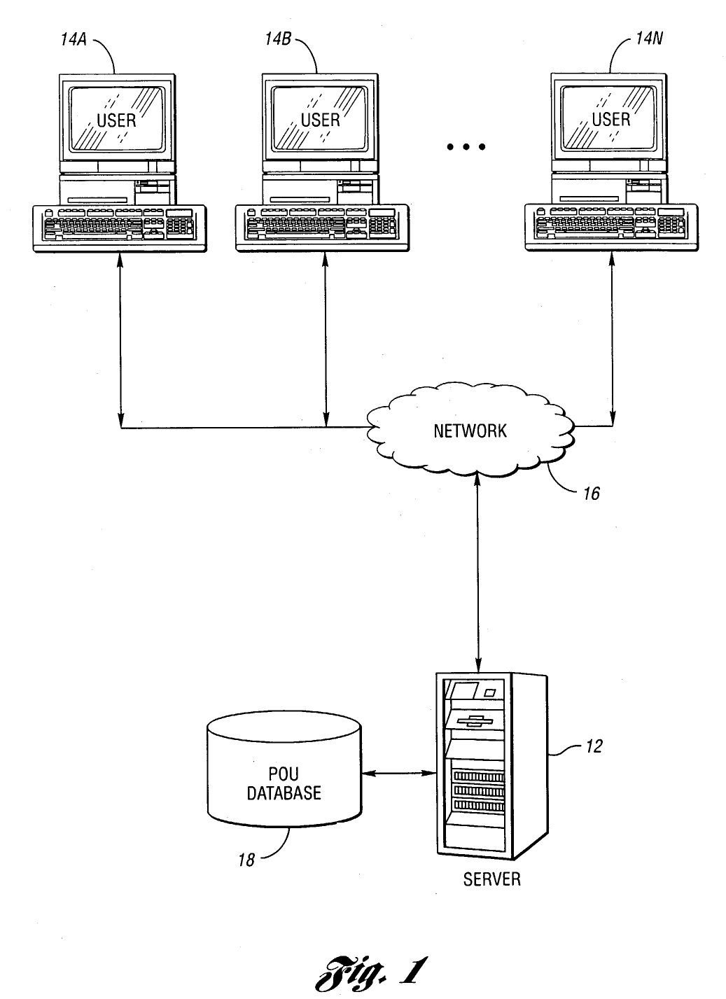

FIG. 1 depicts a schematic diagram illustrating a system embodiment for implementing certain embodiments of the present invention. It should be understood that the diagram is merely exemplary of certain embodiments. Elements of the diagram can be modified, rearranged, deleted, added upon, or amplified based on a particular embodiment of the present invention.

FIG. 1 illustrates an at least one server computer 12 operably serving a plurality of client computers 14A-N, which can communicate with server computer 12 utilizing a TCP-IP communication protocol via network/LAN 16. Server computer 12 can be configured to operably store data to, and retrieve information from, at least one POU database 18.

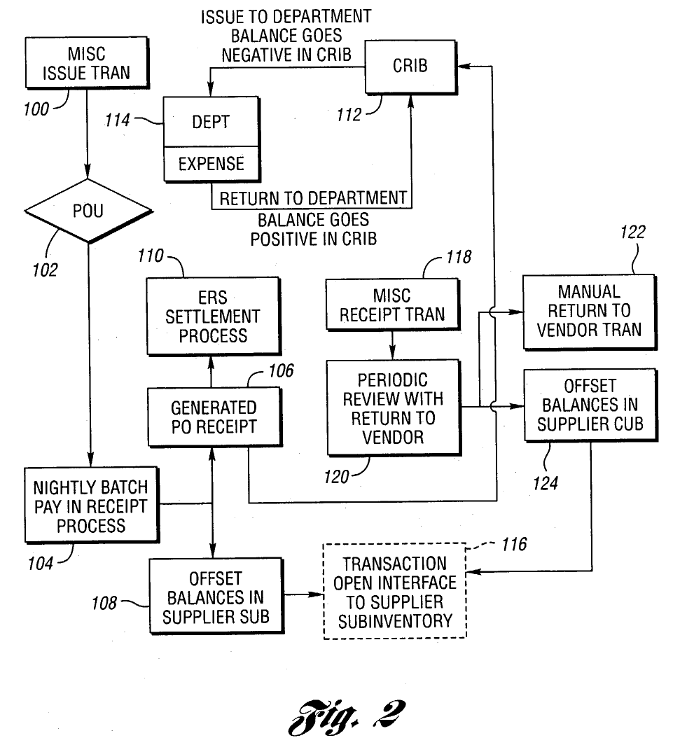

FIG. 2 is a block flow diagram illustrating an overview of a pay on use inventory strategy with respect to a plant inventory organization. The content and arrangement of objects illustrated in FIG. 2 can be rearranged, modified or omitted to best fit a particular implementation.

As depicted in block 100, a miscellaneous issue transaction can be generated through the plant inventory organization. The miscellaneous issue transaction can be transmitted to POU 102 and nightly batch pay on receipt process 104 for processing. The miscellaneous issue transaction can be used to generate a PO receipt 106 and to offset balances in the supplier subinventory 108. The PO receipt can be transmitted for use in the evaluated receipt settlement (ERS) process 110 and in the crib 112. The offset balance can be transmitted to the transaction open interface 116.

As depicted in block 114, an issue to department balance goes negative in crib and a return from department balance goes positive in crib.

As depicted in block 118, a miscellaneous receipt transaction can be generated. As depicted in block 120, the miscellaneous receipt transaction can be transmitted to periodic review with return to inventory. The miscellaneous receipt transaction can be transmitted for use in the manual return to vendor transaction 122 and the offset balances in supplier subinventory 124. The offset balance can be transmitted to the transaction open inventory 116.

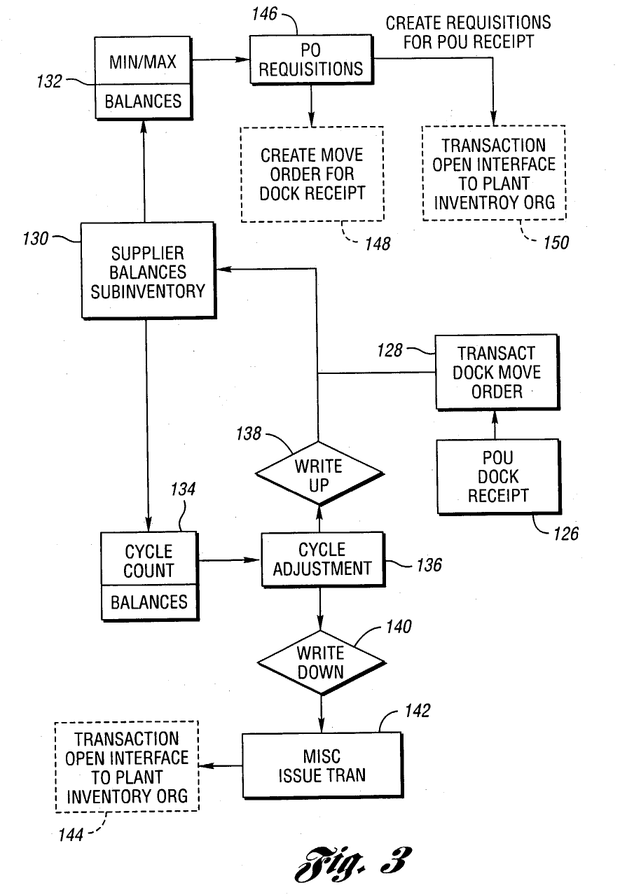

FIG. 3 is a block flow diagram illustrating an overview of a pay on use inventory strategy with respect to a supplier inventory organization. The content and arrangement of objects illustrated in FIG. 3 can be rearranged, modified or omitted to best fit a particular implementation.

In block 126, a POU dock receipt can be received by the supplier inventory organization. The POU dock receipt can be transmitted to the transact dock move order 128 and subsequently to the supplier balances subinventory 130. As depicted in blocks 132 and 134, the POU dock receipt can be transmitted to min/max balances and cycle count balances. The cycle count balances are used for cycle adjustment 136, which may result in a write up 138 and write down 140. If a write down 140 is necessary, it can be transmitted to a miscellaneous issue transaction 142. In block 144, the miscellaneous issue transaction can be transmitted to the transaction open interface to plant inventory organization 144. The min/max balances can be transmitted to PO Requisitions 146. As depicted in blocks 148 and 150, respectively, the PO Requisition information can be transmitted for creating a move order for dock receipt and creating requisitions for POU receipt in the transaction open interface to plant inventory organization.

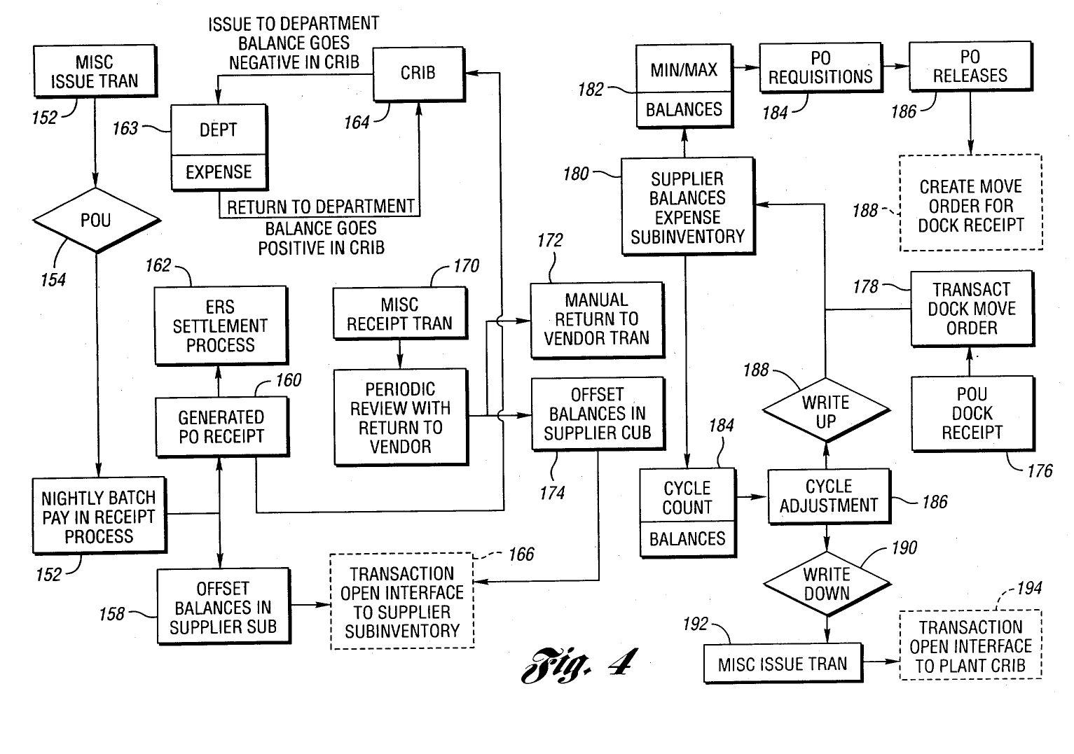

FIG. 4 is a block flow diagram illustrating an overview of a pay on use inventory strategy with respect to a plant sub-inventory within a plant inventory organization. The content and arrangement of objects illustrated in FIG. 4 can be rearranged, modified or omitted to best fit a particular implementation.

As depicted in block 152, a miscellaneous issue transaction can be generated through by the plant inventory organization. The miscellaneous issue transaction can be transmitted to POU 154 and nightly batch pay on receipt process 156 for processing. The miscellaneous issue transaction can be used to offset balances in a supplier subinventory 158 and generate a PO receipt 160. The PO receipt can be transmitted for use in the evaluated receipt settlement (ERS) process 162 and in the crib 164. Offset balances can be transmitted to the transaction open interface 166.

As depicted in block 168, an issue to department balance goes negative in the crib a return from department balance goes positive in the crib.

As depicted in block 170, a miscellaneous receipt transaction can be generated. As depicted in block 172, the miscellaneous receipt transaction can be transmitted to periodic review with return to vendor. The miscellaneous receipt transaction can be transmitted for use in manual return to vendor transaction 172 and offset balances in supplier subinventory 174.

In block 176, a POU dock receipt is generated. The POU dock receipt can be transmitted to the transact dock move order 178 and subsequently to supplier balances expense subinventory 180. As depicted in blocks 182 and 184, the POU dock receipt can be transmitted to min/max balances and cycle count balances. The cycle count balances are used for cycle adjustment 186, which may result in a write up 188 or a write down 190. If a write down is necessary it can be transmitted to a miscellaneous issue transaction 192. In block 194, the miscellaneous issue transaction can be transmitted to the transaction open interface 194 to a plant crib. The min/max balances can be transmitted to PO Requisitions 184. As depicted in blocks 186 and 188, PO Releases can be used to create a move order for dock receipt.

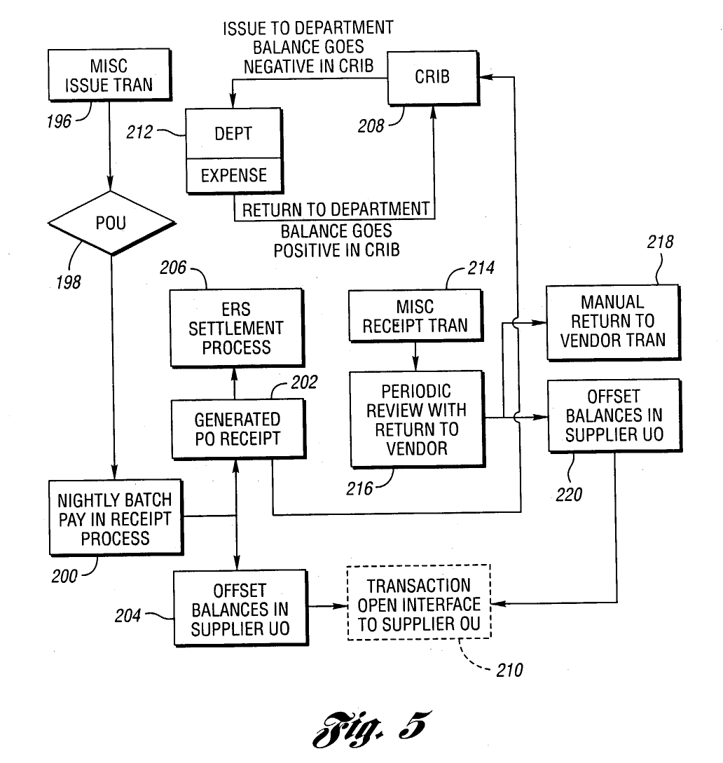

FIG. 5 is a block flow diagram illustrating an overview of a pay on use inventory strategy with respect to a plant operating unit. The content and arrangement of objects illustrated in FIG. 5 can be rearranged, modified or omitted to best fit a particular implementation.

As depicted in block 196, a miscellaneous issue transaction can be generated by a plant operating unit. The miscellaneous issue transaction can be transmitted to POU 198 and nightly batch pay on receipt process 200 for processing. As depicted in blocks 202 and 204, the miscellaneous issue transaction can be used to generate a PO receipt and to offset balances in a supplier operating unit. The PO receipt can be transmitted for use in the evaluated receipt settlement (ERS) process 206 and crib 208. The offset balances can be transmitted to the transaction open interface to a supplier operation unit, as depicted in block 210.

As depicted in block 212, an issue to department goes negative in crib and return from department goes positive in crib.

As depicted in block 214, a miscellaneous receipt transaction can be generated. As depicted in block 216, the miscellaneous receipt transaction can be submitted for periodic review with return to vendor. The miscellaneous receipt transaction can be transmitted for use in the manual return to vendor transaction 218 and offset balances in supplier OU 220. The offset balances can be transmitted to the transaction open inventory 210.

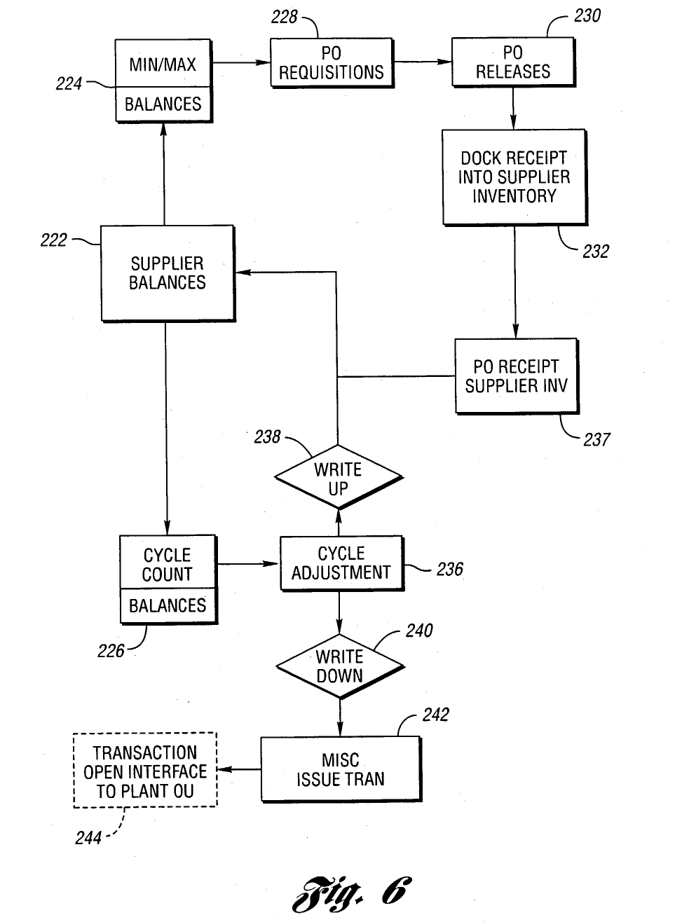

FIG. 6 is a block flow diagram illustrating an overview of a pay on use inventory strategy with respect to a supplier operating unit. The content and arrangement of objects illustrated in FIG. 6 can be rearranged, modified or omitted to best fit a particular implementation.

As depicted in blocks 222, 224 and 226, supplier balances can be generated and sent to min/max and cycle count balances. Min/max balances can be transmitted to PO Requisitions 228. In block 230, PO Requisitions 228 can be transmitted to PO Releases 230. PO Releases can be transmitted to Dock Receipt into Supplier Inventory 232 and PO Receipt Supplier Inventory 234. The PO Receipt Supplier Inventory can be transmitted to supplier balances 22 or write up.

As depicted in blocks 236, 238, and 240, the cycle count balances 226 can be transmitted to cycle adjustment for write up or write down. If a write down 240 is necessary, it can be transmitted to a miscellaneous issue transaction 242. In block 244, the miscellaneous issue transaction can be transmitted to a transaction open interface to plant OU.

It should be understood that pay on use, otherwise referred to as POU, refers to items supplied by suppliers where the buyer does not take ownership until the item has been used. The purchase order receipt that triggers payment is not done until after the material has been requisitioned out of the crib by a miscellaneous issue. The dock receipt and on hand balances are maintained in a Supplier operating unit until the material is issued from the crib. The buyer takes stock keeping responsibility for the material that still remains under the ownership of the supplier.

It should be understood that pay on receipt, otherwise referred to as POR, refers to items that the buyer takes ownership of immediately upon arrival and receipt into inventory. There is only one receipt for these items and the receipt triggers payment.

### Pay On Use Tool Functionality

The pay on use tool includes functionality for a common receiving process for all items, including POR and POU items. As a result of this functionality, shop and crib personnel do not need to know whether an item is POU on order to process the receipt.

The pay on use tool includes the functionality for a common issue process for all items. As a result of this functionality, shop and crib personnel does not need to know whether an item is POU in order to process an issue.

The pay on use tool includes the functionality for visibility of POU item balances. POU items can reside in a subinventory, asset or expense, to maintain balance information.

The pay on use tool includes the functionality for automatic replenishment for POU items. Min/max planning can be used to automatically calculate replenishment for POU.

The pay on use tool includes an ability to evaluate receipt settlement to generate payment for POU.

The pay on use tool includes the functionality to prevent suppliers from seeing pricing information other than their own. As a result of this functionality, the system can restrict access to financial information by supplier.

The pay on use tool includes the ability to cycle count POU items. Inventory write downs can be implemented by issuing, otherwise referred to as buying, inventory and charging it to an adjustment account. Inventory write ups can be implemented by increasing the quantity of supplier owned inventory.

The pay on use tool includes the ability to reduce the amount of obsolescence. The supplier can be restricted from stocking obsolete parts in consigned inventory.

The pay on use tool includes the ability for plants to deal directly with supplier on non-conforming consignment material that has been issued. The supplier can provide a direct exchange for non-conforming material that can eliminate the need for additional accounting transactions. The plant can elect to reverse the purchase receipt through a return to vendor transactions. If the plant chooses the return to vendor transaction, the reversal can be processed against the purchase order receipt generated by the usage transaction.

The pay on use tool includes the ability to periodically reconcile ownership of consigned material in the crib to zero. Negative balances of owned consigned material in the crib can represent unprocessed POU receipts. Positive balances of owned consignment material in the crib can represent material that has been issued and returned to the crib. The purchase order receipt of the material can be reversed before the returned material belongs to the supplier.

The pay on use tool includes the ability to convert a POR item to a POU item.

The pay on use tool includes functionality to interact with the direct material receiving interface. A window requisition issue transaction history can create a purchase order line, a receipt transaction for evaluated settlement, and an issue transaction to offset receipt in the supplier operating unit.

The pay on use tool includes functionality to automatically switch responsibilities in the purchasing receiving screen. Based on the PO number, the receiving screen can switch receiver's responsibility to a valid assigned responsibility for the operating unit that owns the PO. This feature allows the “dock” receipt of POU material to be processed in the supplier operating unit without the receiver having to change the work process.

The pay on use tool includes the ability to lookup the PO number based on the item number. Open PO numbers can be found for items in operating units where the receiver has a validly assigned responsibility. When the item is POU, the PO numbers can be displayed only from the supplier operating unit.

The pay on use tool includes the functionality for an on-hand balances screen that consolidates item balances in the plant inventory organization and supplier operating unit. The on-hand balances screen can display total balance of material that can be issued from the crib regardless of whether the item is POR or POU.

The pay on use tool includes the functionality for shop floor requisition (SFR) to pass consolidated item balances in the plant inventory organization and supplier operating unit. The interface passes the total balance of material that can be issued from the crib regardless of whether the item is POR or POU.

The pay on use tool includes the functionality for a cycle count adjustment screen that properly processes adjustments for POU items. Cycle count adjustment transactions have different processing rules for POU items. The Cycle count adjustment screen can contain additional logic for POU items.

The pay on use tool includes the ability to automate credit memo. A return to vendor in the plant and a miscellaneous receipt in the supplier operating unit from the POU miscellaneous receipt to crib can be created.

### Automated Credit Memo Tool Functionality

The automated credit memo tool includes the ability to return POU material to the crib with a single transaction.

The automated credit tool includes the ability to generate a Purchasing Return to Vendor transaction when POU material is returned to the crib. The Purchasing Return to Vendor can trigger a payment credit for the returned material.

The automated credit tool includes the ability to generate a miscellaneous receipt for the returned POU material in the Supplier operating unit.

A system of implementing the automated credit memo tool functionality can include the following business guidelines:

With respect to a miscellaneous issue regarding a POU item transaction, a standard PO and purchasing receipt transaction can be created through the POU receiving interface. In addition, a miscellaneous issue transaction can be created against the corresponding inventory organization in the supplier operating unit.

With respect to a miscellaneous receipt regarding a POU item transaction, purchasing return to vendor transaction can be created against the last PO receipt through the POU receiving interface. In addition, a miscellaneous receipt transaction can be created against the corresponding inventory organization in the supplier operating unit.

With respect to a cycle adjustment write down regarding a POU item transaction, a standard PO and purchasing receipt transaction can be created through the POU receiving interface. In addition, a miscellaneous issue transaction can be created against the corresponding inventory organization in the supplier operating unit.

With respect to a cycle adjustment write up regarding a POU item transaction, transactions are optionally not generated for this invalid condition.

With respect to a physical write down regarding a POU item transaction, a standard PO and purchasing receipt transaction can be created through the POU receiving interface. In addition, a miscellaneous issue transaction can be created against the corresponding inventory organization in the supplier operating unit.

With respect to a physical write up regarding a POU item transaction, transactions are optionally not generated for this invalid condition.

With respect to scrap regarding a POU item transaction, a standard PO and purchasing receipt transaction can be created through the POU receiving interface. In addition, a miscellaneous issue transaction can be created against the corresponding inventory organization in the supplier operating unit.

The Supplier can own POU material until use. In certain embodiments, any miscellaneous transaction against any subinventory in the Plant can signal the use of POU material.

POU material can be issued from the crib.

The corresponding inventory organization in the Supplier operating unit can be required to assign items to subinventories. The subinventory of the assigned item can generate miscellaneous transactions sent to the Supplier operating unit through the transaction open interface. An item is not assigned to more than one subinventory per inventory organization in the Supplier operating unit.

A POU daily transactions concurrent program for processing daily miscellaneous transactions for POU items is disclosed. According to the concurrent program, when material is issued out of the crib, a purchase order receipt and a miscellaneous issue transaction can be automatically processed. When material is returned to the crib, a return to vendor and a miscellaneous receipt transaction can be automatically processed.

The concurrent program can extract all miscellaneous transactions POU items for the transaction date specified. The concurrent program can generate transactions according to the business guidelines. The generated transactions can be given the same transaction date as the miscellaneous transactions that were extracted.

POU Daily Transactions concurrent program can run after midnight following the end of the transaction date being processed and after all in-flight transactions for the transaction date have completed processing.

A set of launch parameters for the POU daily transactions concurrent program includes, but is not limited to, operating unit name, plant code, and transaction date. The operating unit name refers to the operating unit in which the plant resides. The plant code refers to the organization code for the plant. The transaction date refers to the transaction date for which miscellaneous transactions are preferably extracted.

The log output for the POU daily transactions concurrent program is comprised of the standard normal completion message.

The restart procedure for the POU daily transactions concurrent program includes: (1) identify a checkpoint at the beginning of the process and (2) if an error is encountered, the programs rolls back to the beginning of the process based on the checkpoint.

A system of implementing the automated credit memo functionality tool can include developing customized components that are compatible with an existing Oracle module. The system can include the following modifications and/or configuration to the Oracle Module:

The standard Oracle transaction defaults for receiving POU items can determine the subinventory to which the POU material is delivered by the receipt transaction that generates payment.

The operating unit name of the Supplier operating unit can be stored in a descriptive flexfield of a MTL_PARAMETERS row for the Plant.

The corresponding inventory organization code can be stored in a descriptive flexfield of the MTL_PARAMETERS row for the Plant.

The subinventory code of the main indirect crib can be stored in a descriptive flexfield of the MTL_PARAMETERS row for the Plant.

Receipt and return to vendor transactions do not have to be written directly into Oracle open interface tables. Purchasing transactions can be passed to the POU Receiving Interface while maintaining the ability to back out transactions through a rollback.

Miscellaneous issue and receipt transactions can be written directly to the Oracle transaction open interface tables, but are not committed until processing has completed normally.

To maintain an audit trail, the automatically generated transaction can have the organization code and the transaction I.D. of the original transaction stored in descriptive flexfields. The concurrent program can look up the subinventory in the Supplier operating unit based on what subinventory the item is assigned to. Items are optionally not assigned to more than one subinventory per inventory organization.

### Cycle Adjustment Entry Tool Functionality

The cycle adjustment entry tool includes the ability for a user to enter a cycle count name and have the form automatically switch responsibilities to the Supplier operating unit if the cycle count name is for a POU cycle count.

The cycle adjustment entry tool includes the ability to enter POU cycle counts without switching responsibilities.

The cycle adjustment entry tool provides functionality to create POU cycle count adjustments according to accounting requirements. The accounting requirements for POU cycle count adjustments are different from POR. When inventory is written up for POU, the balances in the Supplier operating unit are increased. When inventory is written down for POU, a miscellaneous issue from the Plant crib is done to the cycle adjustment account. The miscellaneous issue from the Plant crib triggers the POU process to generate a purchase order receipt that initiates payment to the Supplier. Because POU cycle adjustment transactions are generated by a concurrent program, the Approval Required field for the cycle count adjustment can be set to “always” for every POU cycle count name.

The cycle adjustment entry tool includes the ability to automatically switch responsibility based on cycle count name. The list of values for the Cycle Count name can be modified to also include those from the corresponding inventory organization in the Supplier operating unit. If a Cycle Count name is selected from the Supplier operating unit, the responsibility can be automatically switched. The responsibility may need to be automatically switched back.

In certain embodiments, a system of implementing the cycle adjustment entry tool functionality can include the following business guidelines:

The cycle count name follows a naming convention that ensures uniqueness between the buyer operating units and the supplier operating unit.

A cycle adjustment for a POU item in the main crib of the Plant can be written down.

A cycle adjustment for a POU item in the corresponding inventory organization in the Supplier operating unit can be written up.

In other embodiments, a system of implementing the cycle adjustment entry tool functionality can include developing customized components that are compatible with an existing Oracle module. The system can include the following modifications and/or configuration to the Oracle Module:

The operating unit name of the Supplier operating unit can be stored in a description flexfield of the MTL_PARAMETERS row for the Plant.

The corresponding inventory organization code can be stored in a descriptive flexfield of the MTL_PARAMETERS row for the Plant.

The subinventory code of the main indirect crib can be stored in a descriptive flexfield of the MTL_PARAMETERS row for the Plant.

Cycle count names can be stored in the MTL_CYCLE_COUNT_HEADERS table in column cycle_count_header_name. The table can be striped by organization_id. The list of values for cycle count name in the custom cycle count entries form can contain all names for both the plant and the corresponding inventory organization.

Once a cycle count name is chosen by the user, the responsibility can be automatically switched to the operating unit that contains the organization_id for the cycle count name selected.

Unapproved cycle count adjustments for POU items can be found in the MTL_CYCLE_COUNT_ENTRIES. This table can be striped by organization_id. Cycle adjustment transactions can be formatted for all cycle count name entries and placed in the transaction open interface. Transactions can be created according to the business rules for the concurrent program.

A POU cycle adjustment concurrent program for processing cycle adjustments is disclosed. The Create POU Cycle Adjustment can retrieve all the unapproved adjustments from a POU Cycle Count name and can create miscellaneous transactions to implement the accounting adjustments for the count. The POU cycle adjustments concurrent program can run when all entries have been made for a cycle count name.

A set of launch parameters for the POU cycle adjustment concurrent program can include, but is not limited to, plant code, cycle count name, and transaction date for adjustments.

The business guidelines that can be implemented by the POU Cycle Adjustments concurrent program includes:

A POU write up can create a cycle adjustment for the subinventory named in the cycle count entry in the Supplier operating unit. The adjustment increases the balance on-hand in the corresponding inventory organization in the Supplier operating unit.

A POU write down can create a cycle adjustment against the Plant crib subinventory stored in the MTL_PARAMETERS descriptive flexfield. The adjustment can reduce the on-hand balance in the Plant crib and trigger payment to the supplier.

The created cycle count adjustment transactions can be written to the transaction open interface. The cycle count name and count list sequence can be stored in the transaction descriptive flexfields to allow audits against the adjustments created. “POU cycle adjustment” can be placed in the transaction as the source code.

The log output for the POU cycle count adjustment concurrent program can be comprised of the standard normal completion message.

The restart procedure for the POU daily transactions concurrent program can include: (1) identify a checkpoint at the beginning of the process and (2) if an error is encountered, the programs rolls back to the beginning of the process based on the checkpoint.

### Auto Switch Responsibility Tool Functionality

The auto switch responsibility tool includes the ability to receive both POR and POU items with exactly the same work process.

The auto switch responsibility tool includes the ability to check the POU flag the user item type of the destination organization if an item number is entered in the Find Expected Receipts Form. If the item is POU, an expected receipt can be returned from the Supplier operating unit. The user responsibility is automatically switched.

The auto switch responsibility tool includes the ability to locate the operating unit associated with the PO number if the PO number is entered in the Find Expected Receipts Form. If the operating unit is the Supplier operating unit, the user responsibility can be automatically switched. Expected receipts for the destination organization in the Supplier operating unit can be returned.

The auto switch responsibility tool includes the ability to add an edit that requires the user to enter a PO Number or an Item Number when using the custom version of the form.

The auto switch responsibility tool includes the ability to find Expected Receipts by PO Number. The operating unit can be located according to its PO Number. The list of values for the PO Number includes PO Numbers for the user's operating unit and the Supplier operating unit. The Supplier operating unit name can be stored in a descriptive flexfield of the MTL_PARAMETERS row for the destination organization.

If the operating unit is the Supplier operating unit, the inventory organization can be retrieved for the Supplier operating unit that corresponds to the destination organization. The Supplier operating unit inventory organization can be stored in a descriptive flexfield of the MTL_PARAMETERS row for the destination organization.

If the PO Number is in the operating unit, the user's original operating unit and inventory organization can be used and the responsibility is automatically switched back.

The auto switch responsibility tool includes the ability to validate the user responsibility for the Supplier operating unit.

The auto switch responsibility tool includes the ability to switch a responsibility from the Supplier operating unit and to the proper inventory organization.

The auto switch responsibility tool includes the ability to return expected receipts for the Supplier operating unit and corresponding destination inventory organization.

The auto switch responsibility tool includes the ability to find Expected Receipts by Item Number. Item numbers can be located within the destination organization.

If the user item type in the destination organization is POU, the inventory organization for the Supplier operating unit can be retrieved that corresponds to the destination organization. The Supplier operating unit inventory organization can be stored in a descriptive flexfield of the MTL_PARAMETERS row for the destination organization.

The item can be properly enabled in the Supplier operating unit and corresponding destination inventory organization and the user has a valid responsibility for the Supplier operating unit.

If the Item Number is a POR item in the user's original operating unit and inventory organization, the responsibility may have to be automatically switched back.

The auto switch responsibility tool includes the ability to find Expected Receipts by Item Description. The logic can locate the item description in the destination organization item description column. A single item can be retrieved from the user-entered string. Otherwise, the logic can be the same as the lookup by Item Number.

In certain embodiments, a system of implementing the auto switch responsibility tool functionality can include the following user procedures:

A user can find Expected Receipts by the PO Number, Item Number, or a description to match to a single item.

If searching by PO Number, the user can enter the PO Number in the Purchase Order field of the Find Expected Receipts form.

If searching by Item Number, the user can enter the Item Number in the Item field of the Find Expected Receipts form.

If searching by item description, the user can enter the Plant item number immediately followed by a “%” character in the description field of the Find Expected Receipts form. The search by description returns only a single item for the destination organization in the operating unit or else an error message can be displayed.

### POU/POR Conversion Functionality

The POU/POR conversion tool includes functionality to automatically switch the status, i.e. POU to POR or POR to POU, of at least one inventory item. In certain embodiments, the status of a plurality of inventory items can be switched simultaneously.

In certain embodiments, the following steps can be utilized to automatically switch the status. It should be understood that these steps can be rearranged, deleted, and added to depending on the implementation of the present invention.

1. Identify a POR inventory item with a balance on hand in the Main Stores subinventory.

2. Enable the POR inventory item in the supplier operating unit.

3. Set all item attributes in the supplier operating unit but leave planning method as “not planned.”

4. Add the POR inventory item to a Supplier blanket in the supplier operating unit.

5. Assign the POR inventory item to a subinventory in the supplier operating unit.

6. Set frozen cost to zero.

7. Set up receiving defaults in the supplier operating unit.

8. Add the POR inventory item to the Inventory category in the supplier operating unit as POU.

9. Add the POR inventory item to the Supplier Inventory category in the supplier operating unit as POU. The item is now ready to be switched from POR to POU.

10. Return on-hand balance to Supplier through a Purchasing Return to Vendor transaction.

11. Change the user item type in the Plant from POR to POU.

12. Change the Inventory Category in the Plant from POR to POU.

13. Change the Supplier Inventory Category in the Plant from POR to POU.

14. Set the planning method in the Plant to “not planned”.

15. Cancel any open purchase orders or requisitions for the item in the Plant. The item is now ready to be transferred to the supplier operating unit.

16. Create a purchase order to receive against in the supplier operating unit.

17. Receive the item into on-hand in the supplier operating unit.

18. Set the planning method in the supplier operating unit to “min max”.

19. Add the item to the cycle count plan in the supplier operating unit.

20. Remove the item from the cycle count plan in the Plan. The item is now official on POU.

21. The decision is made to switch the item back to POR.

22. Return on-hand balance to Supplier from supplier operating unit through a Purchasing Return to Vendor transaction.

23. Change the status of the item in the supplier operating unit so the item may no longer be transacted.

24. Change the user item type in the Plant from POU to POR.

25. Change the Inventory Category in the Plant from POU to POR.

26. Change the Supplier Inventory Category in the Plant from POU to POR.

27. Create a purchase order to receive against the Plant.

28. Receive the item into on-hand in the Plant.

29. Set the planning method in the Plant to “min max.”

30. Add the item to the cycle count plan in the Plant. The item is now officially on POR.

31. Set the planning method in the supplier operating unit to “not planned”.

32. Remove the assignment to a subinventory in the supplier operating unit.

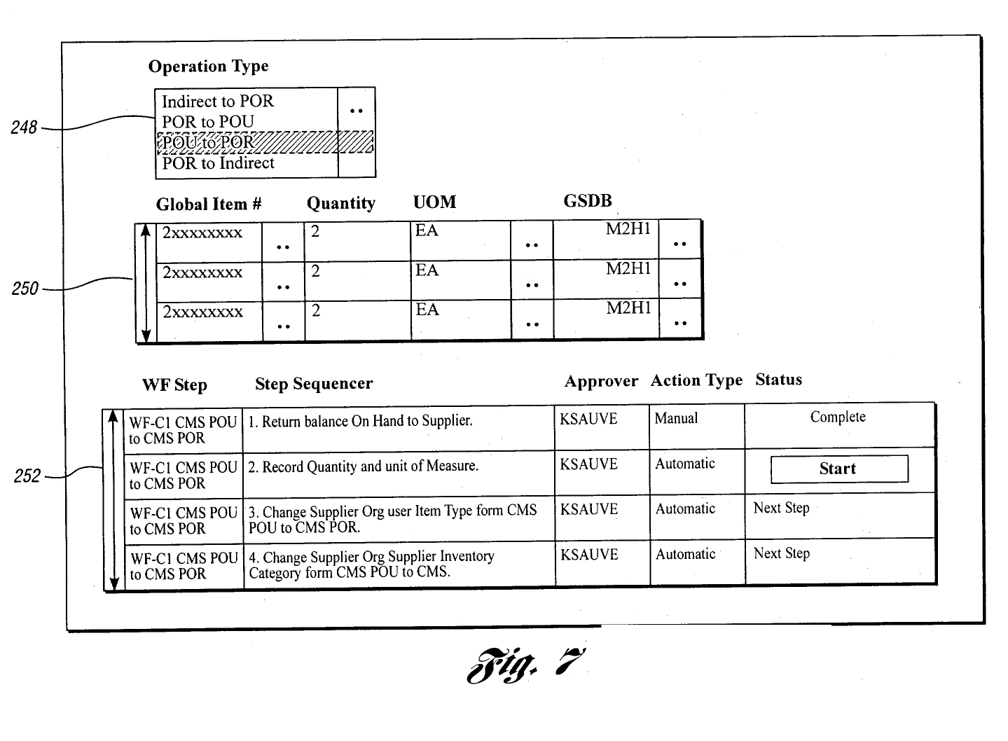

In certain embodiments, The POU/POR conversion tool can be implemented within Oracle procurement. FIG. 7 depicts a workflow tracking form that can be implemented within Oracle procurement in accordance with an embodiment of the present invention.

FIG. 7 includes three selection boxes operation type box 248, item description box 250, and workflow box 252. In certain embodiments, operation types selectable within operation type box 248 can include, but are not limited to, (1) indirect to POR, (2) POR to POU, (3) POU to POR, and (4) POR to Indirect. As depicted in FIG. 7, POU to POR is selected. In certain embodiments, item description box 250 includes columns for global item number, quantity, unit of measure, and global supplier database code (GSDB). As depicted in FIG. 7, values for these columns are listed in a scrollable box for inventory items that can be converted from POU to POR. In certain embodiments, workflow box 252 can include, but is not limited to, columns for workflow step, step sequence, approver, action type, and status. As depicted in FIG. 7, workflow box 252 applies to inventory items selected in item description box 250. The actual operation, as depicted in operation type box 248, can be executed as detailed by the process steps above.

### Pay On Use Receipts Tools

The pay on use receipts tool includes the ability to insert a transaction into the Open Receipts Interface (ORI) tables. The ORI process can create the receipt within Oracle.

The pay on use receipts tool includes functionality used to create a blanket release and shipment when necessary.

The pay on use receipts tool includes functionality to handle the business rules for assigning default expense accounts.

While the best mode for carrying out the invention has been described in detail, those familiar with the art to which their invention relates will recognize various alternative designs and embodiments for practicing the invention as defined by the following claims.

What is claimed:

1. A program for controlling a computer of a server for determining timing of payment of inventory items, the program comprising:
instructions for receiving a plurality of payment on use (POU) and payment on receipt (POR) inventory item descriptions for a plurality of POU and POR inventory items, respectively, supplied by an at least one supplier, the plurality of POU and POR inventory items being maintained in an inventory crib of an at least one plant, the at least one supplier being assigned to an at least one supplier organization, the at least one plant being assigned to an at least one plant organization;
instructions for automatically converting at least one POR or POU inventory item into at least one POU or POR inventory item, respectively;
instructions for receiving a POR purchase order receipt for at least one POR inventory item upon receipt of the at least one POR inventory item;
instructions for receiving a POU purchase order receipt for at least one POU inventory items upon use of the at least one POU inventory item; and
instructions for transmitting a payment message with respect to the at least one used POU or POR inventory item based on the POU or POR purchase order receipt, respectively.

2. The program of claim 1 further comprising instructions for causing maintenance of a dock receipt and an on-hand balance for each POU inventory item.

3. The method of claim 2 further comprising instructions for scheduling the plurality of POU inventory items for a cycle count based on a cycle count guideline.

4. The program of claim 3 further comprising instructions for determining a cycle count discrepancy based on the cycle count.

5. The program of claim 2 further comprising instructions for determining a schedule for a physical count of the plurality of POU inventory items.

6. The program of claim 5 further comprising instructions for determining a physical cycle count discrepancy based on the physical count.

7. The program of claim 2 further comprising instructions for maintaining an inventory item record for the plurality of POU inventory items.

8. The program of claim 2 further comprising instructions for assigning a stock locator to each of the plurality of POU inventory items to the at least one purchaser.

9. The program of claim 2 further comprising instructions for assigning a stock locator to each of the plurality of POU inventory items to the at least one supplier.

10. A computer-implemented method for determining timing of payment of inventory items comprising:
receiving a plurality of payment on use (POU) inventory item descriptions for a plurality of POU inventory items supplied by an at least one supplier, the plurality of POU inventory items being maintained in an inventory crib of an at least one plant, the at least one supplier being assigned to an at least one supplier organization, the at least one plant being assigned to an at least one plant organization;
causing requisition of at least one used POU inventory item maintained in the inventory crib by creating a purchase order receipt;
receiving the purchase order receipt for at least one POU inventory items upon use of the at least one POU inventory item; and
transmitting a payment message with respect to the at least one used POU inventory item based on the purchase order receipt.

11. The method of claim 10 further comprising converting an at least one POU inventory item into an at least one POR inventory item.

12. The method of claim 10 further comprising maintaining a dock receipt and an on-hand balance for each POU inventory item.

13. The method of claim 12 wherein the causing requisition step occurs prior to the causing payment step.

14. The method of claim 10 further comprising receiving the plurality of POU inventory items at an at least one receiving dock.

15. The method of claim 10 further comprising scheduling the plurality of POU inventory items for a cycle count based on a cycle count guideline.

16. The method of claim 15 further comprising determining a cycle count discrepancy based on the cycle count.

17. The method of claim 10 further comprising determining a schedule for a physical count of the plurality of POU inventory items.

18. The method of claim 17 further comprising calculating a physical cycle count discrepancy based on the physical count.

19. The method of claim 10 further comprising maintaining an inventory item record for the plurality of POU inventory items.

20. The method of claim 10 further comprising assigning a stock locator to each of the plurality of POU inventory items to the at least one purchaser.

21. The method of claim 10 further comprising assigning a stock locator to each of the plurality of POU inventory items to the at least one supplier.

22. The method of claim 14 further comprising storing and maintaining pay on receipt (POR) inventory items in the inventory crib.

23. The method of claim 22 further comprising cycle counting the plurality of POU inventory items and the plurality of POR inventory items.

24. The method of claim 22 further comprising window requisitioning the plurality of POU inventory items and the plurality of POR inventory items.

25. The method of claim 22 further comprising credit requisitioning the plurality of POU inventory items and the plurality of POR inventory items.

26. The method of claim 22 further comprising receiving the plurality of POR inventory items at the at least one receiving dock.

27. The method of claim 10 further comprising maintaining a plurality of blanket purchase orders for at least one POU inventory item.

28. The method of claim 27 wherein the maintaining step is at least partially executed by the at least one supplier.

29. The method of claim 10 further comprising aiding in the display of a POU status for at least one POU inventory item, the POU status is selected from the group consisting of a requisitions, purchase orders, receipts, and balances.

30. The method of claim 29 further comprising displaying the POU status on a stock summary user interface.

31. The method of claim 22 further comprising shop floor requisitioning the plurality of POU inventory items and the plurality of POR inventory items.

32. A computer-implemented system for determining timing of payment of inventory items, the system comprising at least one server computer for serving at least one client computer, the at least one server computer being configured to:
receive a plurality of inventory item descriptions for a plurality of payment on use (POU) inventory items, the plurality of POU inventory items being maintained in an inventory crib of an at least one plant, the at least one supplier being assigned to an at least one supplier organization, the at least one plant being assigned to an at least one plant organization;
cause requisition of an at least one used POU inventory item maintained in the inventory crib by creating a purchase order receipt;
receive the purchase order receipt for at least one POU inventory items upon use of the at least one POU inventory item; and
transmit a payment message with respect to the at least one used POU inventory item based on the purchase order receipt.

33. The computer-implemented system of claim 32 wherein the server computer includes at least one supplier database and the at least one server computer is further configured to maintain a dock receipt and an on-hand balance for each POU inventory item in the at least one supplier database.

34. A computer-implemented system for determining timing of payment of inventory items, the system comprising at least one client computer for communicating with at least one server computer, the at least one client computer being configured to:
transmit an inventory item description for a plurality of payment on use (POU) inventory items, the plurality of POU inventory items being maintained in an inventory crib of an at least one plant, the at least one supplier being assigned to an at least one supplier organization, the at least one plant being assigned to an at least one plant organization;
cause requisition of an at least one used POU inventory item maintained in the inventory crib by creating a purchase order receipt;
transmit the purchase order receipt for at least one POU inventory items upon use of the at least one POU inventory item; and
transmit a payment message with respect to the at least one used POU inventory item based on the purchase order receipt.

35. A computer-readable product for determining timing of payment of inventory items, the product being produced by a computer-implemented process, the process comprising:
receiving a plurality of payment on use (POU) inventory item descriptions for a plurality of POU inventory items supplied by an at least one supplier, the plurality of POU inventory items being physically stored and maintained in an inventory crib of an at least one plant, the at least one supplier being assigned to an at least one supplier organization, the at least one plant being assigned to an at least one plant organization;
receiving a purchase order receipt for at least one POU inventory items upon use of the at least one POU inventory item; and
storing the plurality of POU inventory item descriptions and the purchase order receipt in a computer-readable product for use in payment of POU inventory items upon use.
